(19) United States
(12) Patent Application Publication
(10) Pub. No.: US 2016/0130841 A1
(43) Pub. Date: May 12, 2016

(54) WEAPONS CABINET LOCK PLATE

(71) Applicant: The Marvel Group, Inc., Chicago, IL (US)

(72) Inventor: Malgorzata Pala, Burr Ridge, IL (US)

(73) Assignee: The Marvel Group, Inc.

(21) Appl. No.: 14/536,772

(22) Filed: Nov. 10, 2014

(51) Int. Cl. E05B 67/38; E05C 1/10; E05C 7/04

(52) U.S. Cl. CPC E05B 67/38; E05C 7/045; E05C 1/10

(57) ABSTRACT

A storage cabinet having doors including latching mechanisms for securing the doors in a locked position for the safe storage of weapons and related equipment and accessories. A lock plate assembly is used for added security thereof and includes a plate for receiving the latches before the latches are locked together through the shackle of a padlock.

### CROSS-REFERENCE TO RELATED APPLICATION

None.

### BACKGROUND OF THE INVENTION

I. Field of the Invention

The present disclosure relates generally to storage cabinets, and more particularly to the storage of weapons such as rifles, pistols and other firearms, as well as related equipment and accessories, and more specifically to a lock plate assembly used for added security thereof.

II. Description of the Prior Art

In certain military, police and other environments, there is a need to safely and securely store firearms and related equipment in a manner such that the firearms and related equipment are quickly and easily accessible when necessary. There is a further need to ensure that firearm storage occupies a minimal amount of space, especially when open, since it is frequently the case that personnel must quickly gain access to the firearms and related equipment.

Local, state and federal agencies typically purchase, utilize and maintain supplies, equipment, furniture and other staples in great numbers. This provides consistency between agencies, allows the agencies to negotiate better purchase prices and further provides ease in maintenance thereof. Accordingly, and in regard to weapon storage cabinets, many agencies use a cabinet with mesh bi-fold doors such as described in U.S. Pat. No. 7,524,002, which is hereby incorporated by reference herein. Various latching mechanism may be employed within such cabinets, but most incorporate latches that are secured with a padlock and the like.

It is well known that these current weapon storage cabinets, with their latch and padlock combination, provide good security for the items stored therein. However, there still exists a need to provide added security to such designs.

Accordingly, it is a general object of this disclosure to provide a cost effective and easy to use additional security measure to existing weapons storage cabinets.

It is a more specific object of the present disclosure to provide a lock plate assembly for existing weapons storage cabinets.

These and other objects, features and advantages of this disclosure will be clearly understood through a consideration of the following detailed description.

### SUMMARY OF THE INVENTION

According to an embodiment of the present disclosure, there is provided a lock plate assembly for use with a storage cabinet having doors with free ends that close adjacent one another, each door having a latch slidable in a horizontal linear direction between a latched position towards a midline and an unlatched position away from the midline, the lock plate having an aperture for receiving the latches.

### BRIEF DESCRIPTION OF THE DRAWINGS

The present disclosure will be more fully understood by reference to the following detailed description of one or more preferred embodiments when read in conjunction with the accompanying drawings, in which like reference characters refer to like parts throughout the views and in which:

FIG. 1 a frontal perspective view of one example of a cabinet capable of using the lock plate assembly according to the principles of an embodiment of the present disclosure.

FIG. 2 is a front view of the cabinet of FIG. 1 with the attached lock plate assembly according to the principles of an embodiment of the present disclosure.

FIG. 3 is an inside perspective of the door and latch mechanism of FIG. 1 with the latch in the latched position.

FIG. 4 is an enlarged view of the latch mechanism of FIG. 3.

FIG. 5 is an inside perspective of the door and latch mechanism of FIG. 1 with the latch in the unlatched position.

FIG. 6 is an enlarged view of the latch mechanism of FIG. 5.

FIG. 7 is an enlarged perspective view of the latch of FIG. 1.

FIG. 8 is an enlarged frontal view of the lock plate assembly according to the principles of an embodiment of the present disclosure.

FIG. 9 is an enlarged perspective view of FIG. 7 with the lock plate subassembly of FIG. 8 secured to the cabinet.

FIG. 10 is an enlarged perspective view of FIG. 7 with the lock plate subassembly secured to the cabinet and the plate over the latch before padlock locking.

### DESCRIPTION OF THE PREFERRED EMBODIMENTS

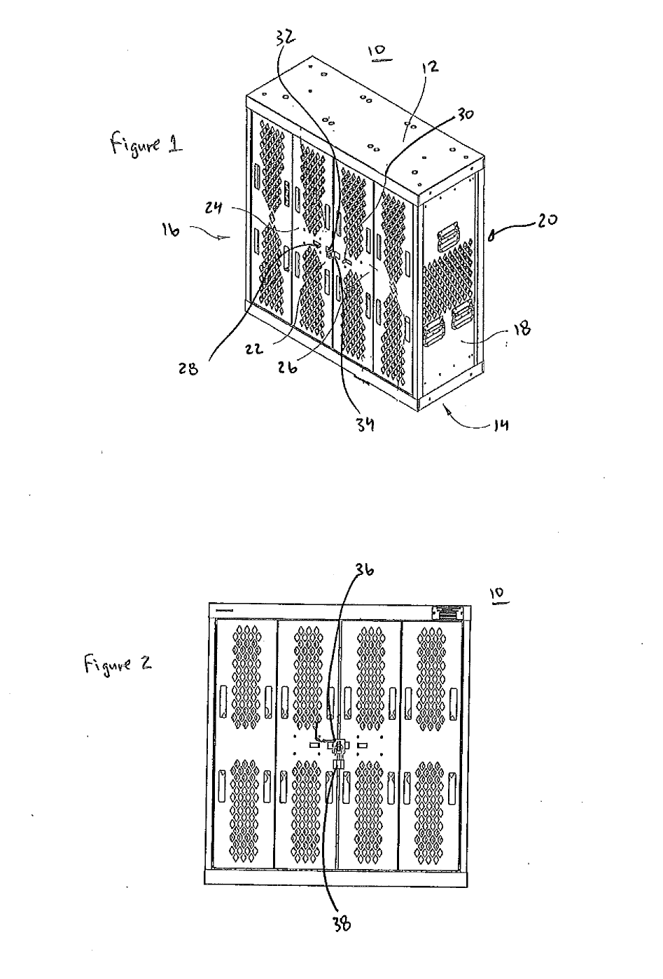

One or more embodiments of the subject disclosure will now be described with the aid of numerous drawings. Turning first to FIG. 1, the cabinet 10 includes a top 12, bottom 14, left side 16, right side 18, back 20 and front 22. The front includes a pair of bi-fold doors (24, 26) and their respective latch handles (28, 30) and latches (32, 34). FIG. 2 illustrates the cabinet 10 with the subject lock plate assembly 36 of the present disclosure and a padlock 38.

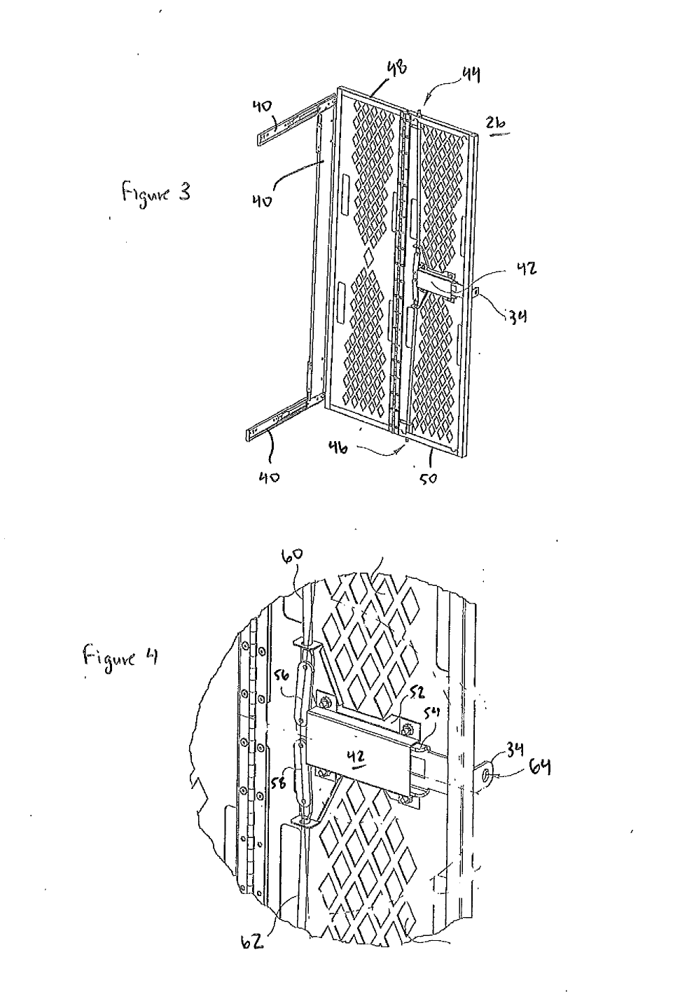

FIG. 3 is an inside perspective view of the right side bi-fold door 26 of FIG. 1 shown in an open position away from the cabinet doorframe 40. Although away from the doorframe 40, the latch assembly guide 42 is shown in the locked position whereby upper rod tip 44 and lower rod tip 46 are extended past the top 48 and the bottom 50 of the door 26, respectively. As such and when closed against the doorframe 40, the rods engage the doorframe 40 and lock the doors closed. FIG. 4 illustrates an enlarged view of the latch assembly guide 42 of FIG. 3. In particular, the assembly guide 42 includes a housing 52 and slide 54. When the latch 34 is in the shown closed position, the guide holds the upper and lower linkages (56, 58) in an upright position, which in turn keeps the upper and lower rods (60, 62) in an extended and locked position. A padlock 38 through the hole 64 in the latch 34 (and latch 32) keeps the doors in this locked position, as will be described.

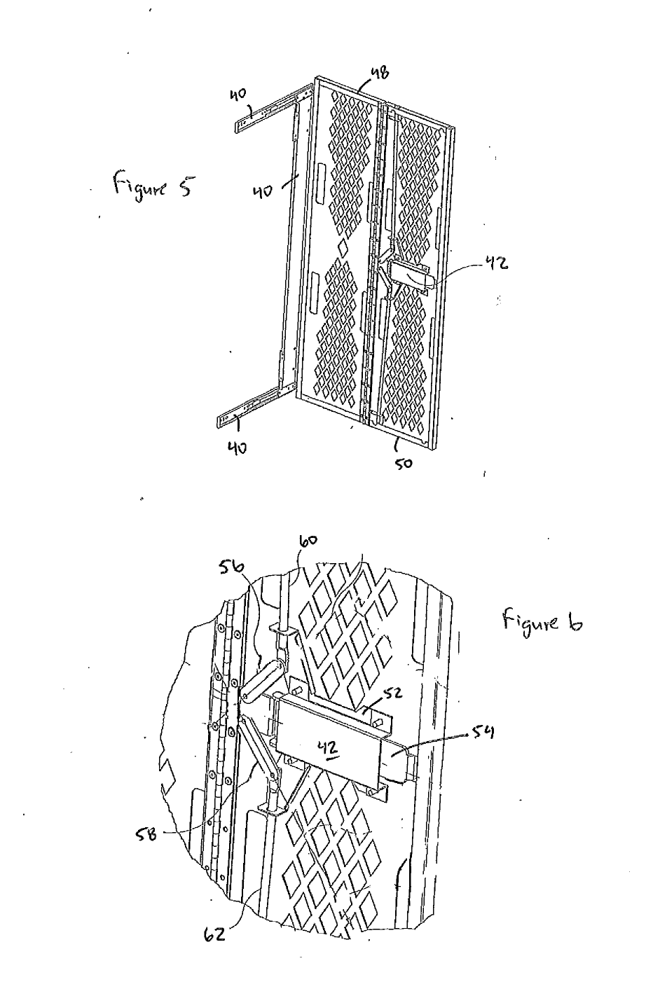

FIGS. 5 and 6 illustrate the same elements as described in FIGS. 3 and 4, but are in the open position rather than the closed position. Specifically, when the latch is in the open position, the guide 42 holds the upper and lower linkages (56, 58) in an angled position, which in turn moves the upper and lower rods (60, 62) into the door and their respective tips do not protrude the top 48 or bottom 50 thereof.

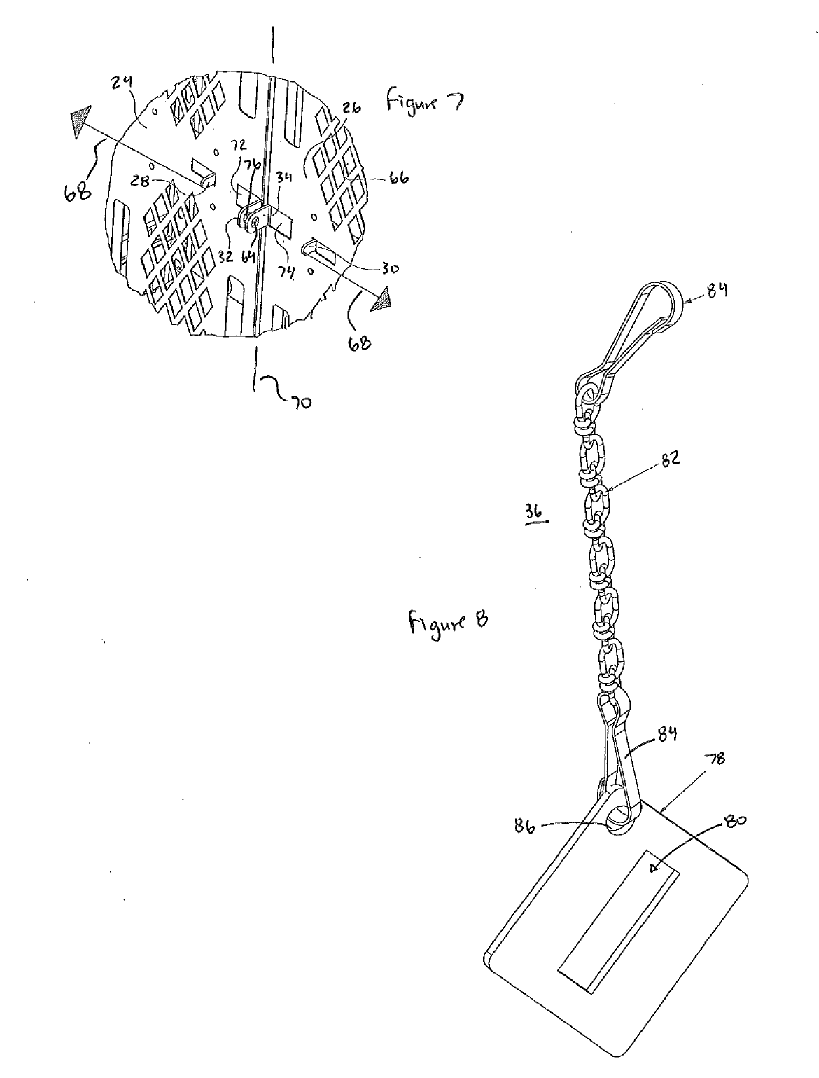

FIG. 7 is an enlarged perspective view of the front latches of the double bi-fold doors (24, 26) in a closed and locked position. The doors comprise of a mesh structure, such as with opening 66, allowing substantial ventilation and visibility of an inside of the cabinet. While the latches themselves (32, 34) provide a means to linearly 68 slide away from the midline 70 of the cabinet in a horizontal direction, and thereby unlock and open the doors, additional protrusions in the form of handles (28, 30) are part of their respective slides (72, 74) and allow additional means to linearly 68 slide open the doors. Latches (32, 34) each have a hole, 76 and 64 respectively, to receive the shackle of a padlock 38 (as shown on FIG. 2) when the left latch 32 and the right latch 34 are slid in the latched position toward the midline 70.

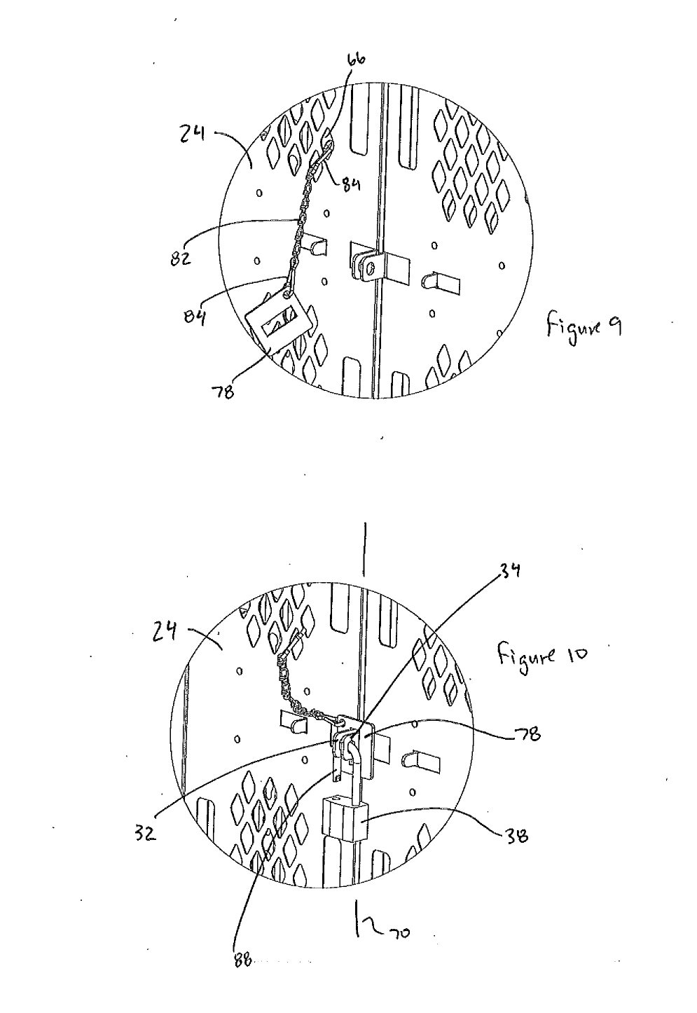

The lock plate assembly 36 according to the principles of an embodiment of the present invention is shown in FIG. 8. The assembly 36 includes a plate 78 with a latch aperture 80. The assembly also optionally includes a means to couple the plate to the cabinet door. In particular, the present embodiment includes a double loop chain 82 with each end thereof having spring snaps 84. One spring snap secures the plate 78 via a hole 86 therein, while the other spring snap is secured to the cabinet door 24 via openings 66, see FIG. 9. It will be appreciated that the plate can be coupled to the cabinet by any appropriate lanyard and associated connectors.

In use, and referring to FIG. 10, when the latches are slid towards the midline 70 and the doors are accordingly in the locked position, the aperture 80 of the plate 78 slides over both the left latch 32 and the right latch 34. The shackle 88 of the padlock 38 is received by the latch holes and secures the latches, and accordingly the doors, in the locked position. The plate 78 provides added security by both aiding in securing the latches toward the midline as well as any potential manipulation of the door while the padlock is engaged and locked.

The foregoing detailed description has been given for clearness of understanding only and no unnecessary limitations should be understood therefrom. Accordingly, while one or more particular embodiments of the disclosure have been shown and described, it will be apparent to those skilled in the art that changes and modifications may be made therein without departing from the invention if its broader aspects, and, therefore, the aim in the appended claims is to cover all such changes and modifications as fall within the true spirit and scope of the present disclosure.

What is claimed is:

1. A lock plate assembly for use with a storage cabinet having a left door and a right door each having a free end wherein the free ends are adjacent one another along a vertical midline where the cabinet is in a closed position, a left latch on the left door and a right latch on the right door wherein the latches are slidable in a horizontal linear direction between a latched position towards the midline and an unlatched position away from midline whereby said latches are adjacent one another when the doors are closed and latched, the assembly comprising a plate having an aperture for receiving said adjacent latches.

2. The assembly as defined in claim 1 further comprising a lanyard having a connector on each end thereof whereby one connector couples said cabinet and the other connector couples said plate.

3. A cabinet and lock plate combination comprising:
a left door and a right door each having a free end wherein said free ends are adjacent one another along a vertical midline when said cabinet is in a closed position;
a left latch on said left door and a right latch on said right door wherein said latches are slidable in a horizontal linear direction between a latched position towards said midline and an unlatched position away from said midline, said latches are adjacent one another when said doors are closed and latched; and
a plate having an aperture to receiving said adjacent latches.

4. The combination of claim 3 further comprising a lanyard having a connector on each end thereof whereby one connector couples said cabinet and the other connector couples said plate.

5. The combination of claim 3 wherein said latches include apertures for receiving a shackle of a padlock.
